(19) United States
(12) Patent Application Publication
(10) Pub. No.: US 2017/0181575 A1
(43) Pub. Date: Jun. 29, 2017

(54) APPLIANCE FOR BAKING BREAD

(71) Applicant: Yilma Asfaw, Bellaire, TX (US)

(72) Inventor: Yilma Asfaw, Bellaire, TX (US)

(21) Appl. No.: 14/981,919

(22) Filed: Dec. 29, 2015

(51) Int. Cl. A47J 37/06; A21B 5/00

(52) U.S. Cl. CPC A47J 37/0611; A21B 5/00

(57) ABSTRACT

An appliance for baking flatbread, mainly Ethiopian flatbread commonly known as Injera, sometimes known as Enjera. The appliance comprises: a lid, two lid handles, a pan with baking surface, two pan handles, four pan legs, a thermostat and a heating element. The appliance is an electric metal pan which may be made of aluminum, coated with non-sticking materials such as PTFE or alternatively ceramic or silicon. The electric pan may also be made of other metals that include stainless steel, iron or enameled cast iron. The appliance lid has a mechanism to remove condensed water away from the electric pan.

### TECHNICAL FIELD

This invention relates to an appliance for baking flatbread, mainly Ethiopian flatbread known as Injera, also known as Enjera. The same appliance may be used to bake, cook or fry any food.

### BACKGROUND OF THE INVENTION

Injera is a flatbread which is circular, spongy and thin; widely known in Ethiopia and some neighboring countries to include Eritrea, Somalia and Sudan. Sometimes it may be called Enjera. Injera has a vesicular texture and sour test. Injera is usually made of teff flour in Ethiopia. Some people add barely, millet, sorghum, wheat, rice and maize flours with teff when preparing Injera batter. Most Ethiopians in the diaspora, mainly in North America, add self-rising flour (bleached wheat flour mixed with double acting baking powder) in the Injera batter. Teff is the smallest grain grown mainly in Ethiopia.

The majority of Ethiopian people bake Injera on a traditional clay plate/pan called Mitad. The traditional Mitad plate has a cover/lid made of bamboo, hay, mud and/or cattle drops. The lid absorbs extra moisture when baking commences. The traditional Mitad plate can have diameters ranging from 54 cms (21.26 inches) to 62 cms (24.41 inches). The most common traditional Mitad plate diameter is 58 cms (22.84 inches). The Mitad can have thickness of 2.5 cms or thicker in some cases. Most people put Mitad plate over three equal height stones traditionally called “Gulicha”, the stones are put in a triangular pattern, away from the Mitad plate center and close to the periphery of the plate. When baking commences, the space between the ground and bottom Mitad pan surface used to burn dry wood, plant residues, animal dung and/or charcoal.

Some researchers indicated that the traditional Mitad plate has efficiency as low as 5%. Some people use the same clay Mitad with electricity as a source of energy. However, because of thick insulation and detachable legs on the electric Mitad, it may weigh 25 kgs or more. The insulation is made of soil, gypsum and/or pumice. Some researchers indicated electric Mitads are still very low in energy efficiency which counts for heat loss at the bottom and sides of the Mitad plate. There are also heat loss when lifting the Mitad's cover, heat loss due to low thermal conductivity of the clay plate and heat loss during overheating, as electric Mitads do not have thermostatic control. Traditionally most Ethiopians pour Injera batter on the baking surface in a spiral pattern, beginning from the center of the Mitad plate towards the periphery of the Mitad plate. Research indicated most people tend to pour slightly more Injera batter on the center of the Mitad, when pouring starts, than on the periphery of the pan. This results in the Injera becoming thicker at the center.

There is no metal electric pan/plate on the market that can bake 60 cms Injera. A couple of people patented flatbread baking electric metal pans that may bake 40 cms diameter Injera but none of the designs are capable of baking 60 cms diameter Injera. Unfortunately, a lot of energy is wasted in the Injera baking processes when using traditional Mitad plates and electric Mitads. Some research papers indicated aluminum has a thermal diffusivity of 84.18×10 ⁻⁶ m²/s and common brick may have a thermal diffusivity of 0.52×10⁻⁶ m²/s. High thermal diffusivity of aluminum may indicate heat moves rapidly relative to aluminum's volumetric heat capacity as compared to common brick; Mitad plate may have a similar composition and thermal diffusivity to common brick. Properties of Mitad plate may vary based on many things such as mineralogical composition of the plate, density, porosity etc. Assuming no heat loss differences on Mitad plate and aluminum pan, for the same diameter and thickness, aluminum pan may transfer heat and evenly heat up about 162 times faster than Mitad plate. The invented electric metal pan may have a thickness of about 5.5 mm (0.0055 m) and Mitad plate may have a thickness of 2.5 cms (0.025 m). Heat transfer is inversely related to thickness of materials hence aluminum pan will be about 4.5 times thinner than Mitad plate. Assuming all other conditions are constant, the invented pan will transfer heat and evenly heat up 728 times faster than Mitad plate (common brick). Of course, heat loss on aluminum pan is higher as heat loss is a function of thermal conductivity besides temperature difference and areas exposed to heat loss. In addition, thermostat on the electric metal pan may help to switch power on and off keeping a constant baking surface temperature; that in turn saves additional energy wasted during Injera baking processes, as traditional electric Mitads do not have thermostats.

It is a general objective of this invention to provide an improved appliance for baking flatbread, more specifically Injera. The appliance will help save much energy which is wasted during Injera baking processes when using traditional Ethiopian clay Mitad plates and electric clay Mitads. The invented electric metal pan is also much lighter than electric Mitad. The appliance can be put on the table or on the ground when baking commences. The appliance can be put under the table or in any small available space in the room when not in use. The appliance can be made of metals such as aluminum, stainless steel, enameled cast iron or iron coated with non-stick materials such as PTFE, silicon or ceramic. The appliance can also be used to bake, fry or cook any food.

### BRIEF DESCRIPTION OF THE DRAWINGS

This invention will be better understood from the following detailed description of the invention taken in conjunction with the accompanying drawings:

FIG. 1 is a perspective view of the appliance and all parts of the present invention;

FIG. 2 is a front view of FIG. 1;

FIG. 3 is a bottom view of FIG. 1;

FIG. 4 is the perspective view of the present invention showing electric pan with closed lid;

FIG. 5 is detail A from FIG. 4, and illustrates components at the back of FIG. 4;

FIG. 6 is a top view of the appliance with lid in open position;

FIG. 7 is section B-B′ from FIG. 6;

FIG. 8 is detail C from FIG. 7;

FIG. 9 is a top view of the present invention with lid in closed position;

FIG. 10 is detail F from FIG. 11;

FIG. 11 is section D-D′ from FIG. 9;

FIG. 12 is detail E from FIG. 11;

### DETAILED DESCRIPT OF THE INVENTION

The invention comprises an electric metal pan for baking flatbread, mainly Injera. For better understanding of the invention all the drawings are categorized into three: drawings to describe main electric metal pan parts, a drawing to show bottom part and drawings to describe the condensed water removal system.

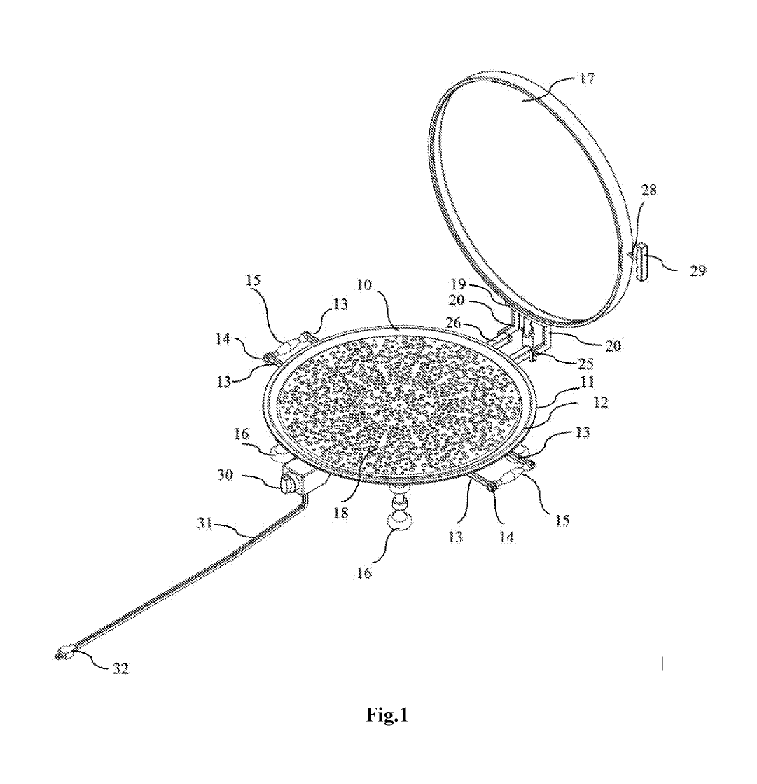

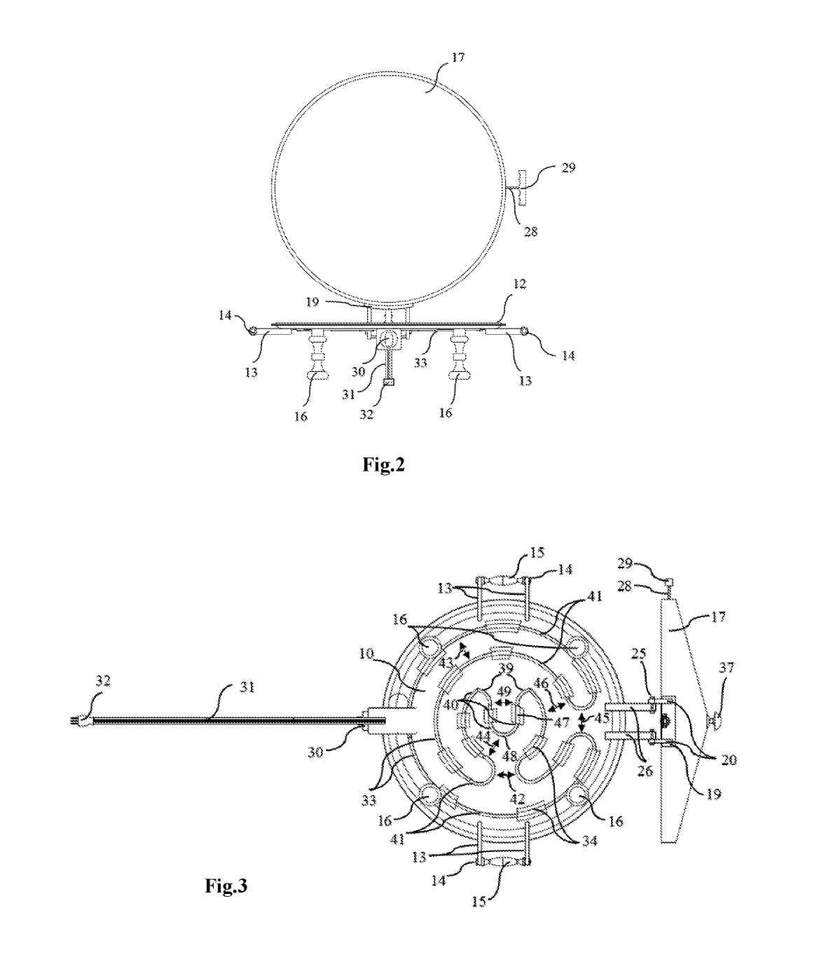

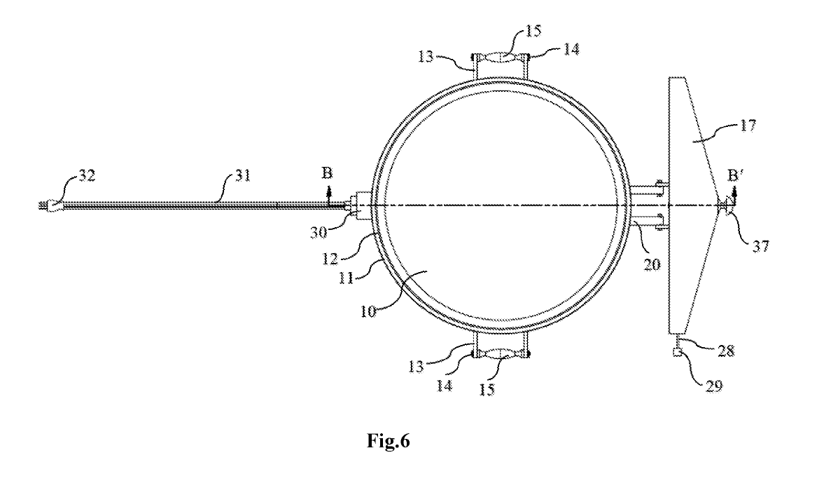

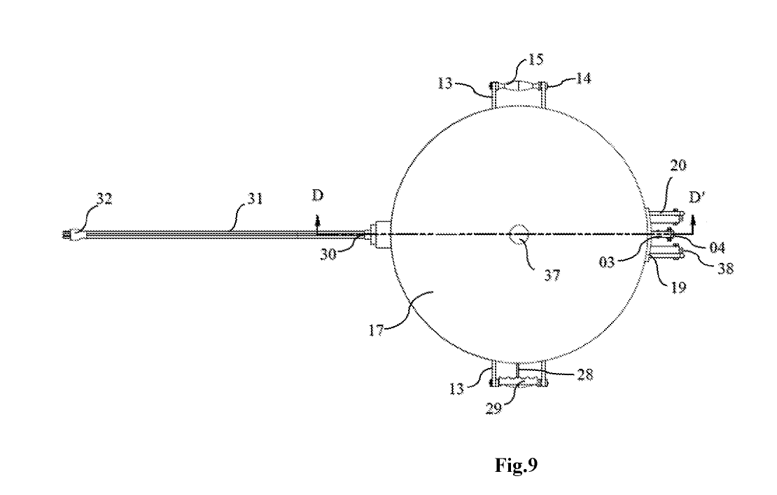

FIG. 1, FIG. 2, FIG. 6 and FIG. 9 describe main electric pan parts. The appliance is an electric metal pan which has a circular pan with baking surface 10, the pan has two pan handles 15, a lid 17 to cover baking surface when baking commences, the lid has two handles 29, 37. The lid 17 is conical in shape with cylindrical periphery, it may be made of glass on the top conical part and it may be made of stainless steel or aluminum at the bottom cylindrical part. The glass lid 17 allows monitoring of baking progress without lifting the lid and without allowing moisture to escape. As shown in the drawings, the lid 17 attached to arc shaped metal 19 using screws, the arc shaped metal 19 is attached to the main electric pan 10 using L shaped bars 20 and metal bars 26, L shaped metals are hinged 25 to metal bars 26, in this configuration, handle 29 may be used to open lid 17 when baking commences. Handle 29 is attached to lid 17 with a metal bar 28. The lid 17 can also be detached from the main electric pan 10 by disconnecting hinge 25 and removing L shaped bars 20 and arc shaped bar 19. In this configuration handle 37 may be used to remove the lid from the main pan 10 when baking commences. The electric pan 10 has four legs 16, a thermostat 30 to control constant temperature on the baking surface 10. The thermostat 30 is connected to a cable 31 and the cable 31 is connected to electric plug 32. The pan 10 has two handles 15 which are orthogonal to the thermostat 30 and lid hinges 25.

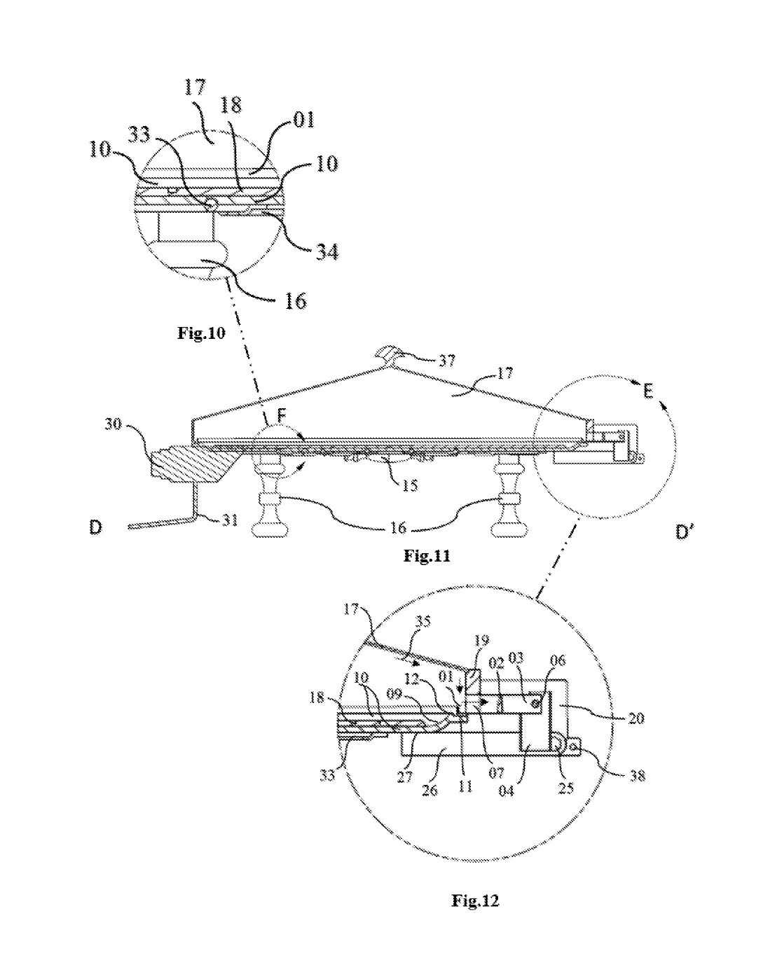

FIG. 3 describes the bottom of the electric metal pan, a heating element 33 on the bottom has a unique pattern for uniform distribution of heat on the baking surface 10. The heating element 33 has a shape of letter C on the outer periphery 41 and it has a shape of letter Y on the center 40, the C shaped and Y shaped heating element are connected to form a single heating element 33. The distance 43 between heating element 33 that forms the letter C shape 41; the distance 44 between heating element 33 that forms the letter Y shape 40; the distance 42 between heating element that connect Y shaped and C shaped heating element; the gap 45 between heating element 33 that form C shape 41; the distance 49 between two arms of Y shaped 40 heating element 33 are all equal. At the center of the electric metal pan, the Y shaped 40 heating element 33 has a half circular 48 shape and straight section 47. The tip 39 of Y shaped 40 heating element 33 has a bigger radius that radius of circular shape 48 heating element 33 for uniform distribution of heat on electric pan surface 10. The electric pan has four legs 16, away from the center of the pan, close to the periphery of the electric pan 10 to give a better support and balance to the electric metal pan when the lid opens. In addition, the four legs 16 help to keep the heating element 33 away from the surface it is seating, especially when baking commences. As shown on FIG. 10, about half portion of heating element is embedded in the pan 10 bottom for better heat conduction from the heating element 33 to the aluminum pan baking surface 10. The heating element 33 is held in place by metal bars 34 which has an omega shape in section view. The inside diameter of the omega shape bars 34 is the same as the outside diameter of heating element 33. The electric pan 10 has two handles 15 which are screwed 14 to the metal bars 13.

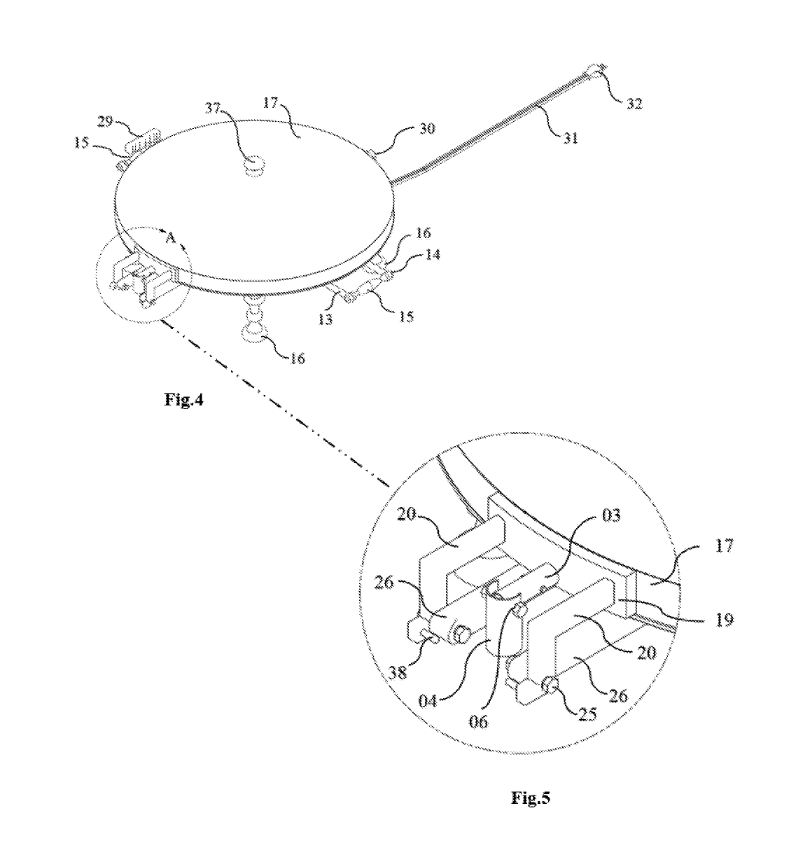

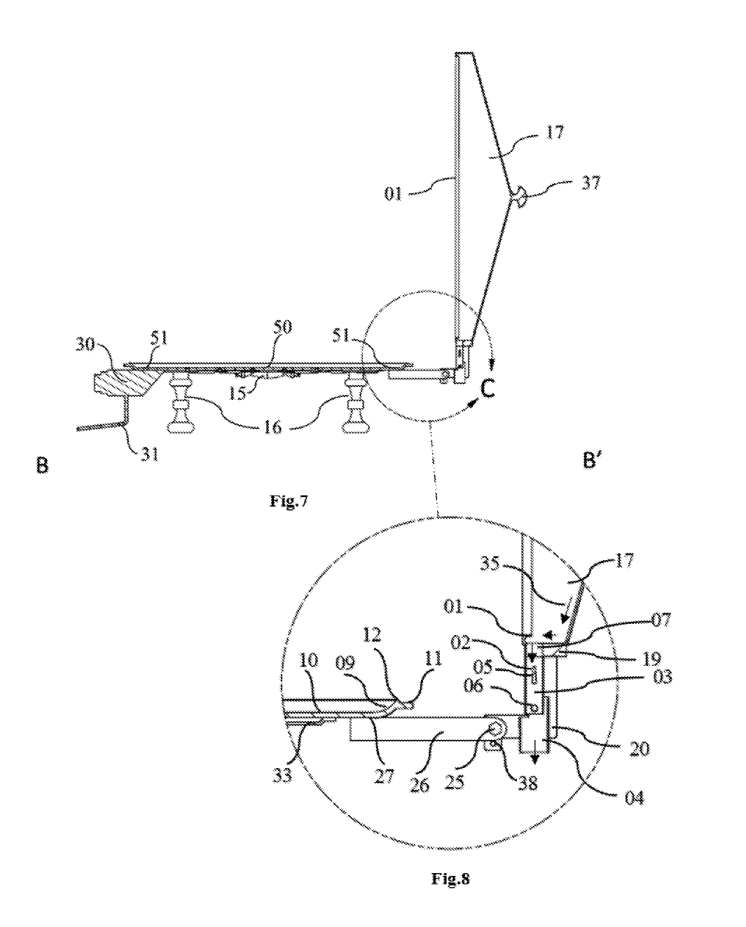

FIG. 4, FIG. 5, FIG. 7, FIG. 8, FIG. 10, FIG. 11 and FIG. 12 mainly describe the condensed water removal system from the electric pan 10. The appliance has a baking surface 10 which has low relief conical shape, the tip of the cone 50 is at the center of the pan 10 and the periphery of cone 51 is away from the pan 10 center. Most Ethiopians pour Injera batter in a spiral fashion beginning from the center of the pan 10, people tend to pour slightly more batter when start pouring and the conical shape of the pan 10 may allow gravity to force batter to move from the center towards the periphery the pan surface 10, it may intern help to distribute batter to a uniform thickness. At the outer periphery of the baking surface 10, the pan has a concave shape 09 which helps make the periphery of Injera 18 ultra-thin. The pan 10 has a protruding rim 12, the rim 12 helps to align lid 17 on pan 10 surface properly when lid closed FIG. 4. The outer most periphery of the pan has a flat surface 11 to support lid 17 when the lid is in a closed position. The lid has a supporting metal bar 19 which is attached to two L shaped bars 20. The L shaped bars 20 are hinged 25 to two metal bars 26 which are welded 27 to the pan 10 bottom. The L shaped metals 20 and arc shaped metal 19 can be removed from the lid 17 to use the appliance similar to traditional Mitads. In which case, handle 37 may be used to remove the lid 17 from the baking surface 10 when Injera 18 is ready to be picked. Ethiopian traditional Mitad plates do not have a mechanism which attaches the lid 17 with the Mitad plate 10. As steam comes off the Injera 18 when baking commences, water start condensing on the lid 17 inside surface, the condensed water from the inside surface of lid 17 pours downward 35 to the water collector 01 due to gravity. The water collector 01 collects condensed water when the lid 17 is in closed position as shown on FIG. 11. When the lid 17 opens FIG. 7, the water collected in the water collector 01 pours through a hole 07 towards tube 03, tube 04 has a wider diameter than tube 03 and it is hinged 06 loosely to tube 03. Due to gravity, tube 04 always hangs downward whether the lid 17 is in an open FIG. 7 or closed position FIG. 11. As shown on FIG. 8 and FIG. 12, a small circular metal plate 02 inserted inside tube 03, the metal plate 02 is thin on the top half and thick on the bottom half. The metal plate 02 is hinged 05 to tube 03, the connection is loose so that gravity always aligns the plate 02 vertical whether the lid 17 is in open FIG. 7 or closed position FIG. 11. The plate 02 closes the inside passage of tube 03 when baking commences so that steam will not escape, the plate 02 opens by gravity when lid 17 is in an open position FIG. 7 and condensed water from inside surface of lid 17 escapes through tube 03 and tube 04 to the ground. Pins 38 stop the pan lid 17 from opening more than certain degree, normally 95-100 degrees from the pan surface 10. As shown on FIG. 8, pins 38 touched the bottom surface of metal bar 26 to stop further opening of pan lid 17.

The connections, parts/components, methods mentioned in this invention are well known in the field of the invention and may easily be understood by persons skilled in the art of science, so details of connections, parts/components, methods are not discussed in very detail.

The invention shown from FIG. 1 to FIG. 12 and the above detailed description of the invention shown is the preferred method of flatbread baking appliance, mainly Injera. In this invention, modification, re-arranging, alteration of different parts in the appliance may be made within the scope of the invention as set forth in the following claims.

What is claimed is:

1. An appliance for baking flatbread, mainly Injera comprising: an appliance lid, two lid handles, a pan with baking surface, two pan handles, four legs, a thermostat, a unique heating element pattern (C-Y pattern) and a condensed water removal system.

2. The appliance for baking flatbread as set forth in claim 1, wherein said appliance lid has a conical shape on top and cylindrical shape on the bottom.

3. The lid of electric metal pan as set forth in claim 2, wherein said appliance lid can be both attachable and detachable.

4. The lid of electric metal pan as set forth in claim 2, wherein said appliance lid has two handles, the first handle for attachable lid configuration and the second handle for detachable lid configuration.

5. The lid of electric metal pan as set forth in claim 2, wherein said appliance lid has a mechanism to collect condensed water and remove it from the pan.

6. The lid of electric metal pan as set forth in claim 2, wherein said the lid has a hole for condensed water removal.

7. The lid of an electric pan as set forth in claim 2, wherein said lid has a narrow tube attached to the hole for condensed water removal.

8. The lid of electric metal pan as set forth in claim 7, wherein said the lid has a wide tube loosely hinged to smaller tube to direct removal of condensed water vertically down.

9. The lid of electric metal pan as set forth in claim 7, wherein said appliance has circular metal plate inside the narrow tube to stop steam from escaping when the lid closed.

10. The lid of electric metal pan as set forth in claim 9, wherein said the circular metal plate is thin on the top half and thick on the bottom half, always to keep aligning the plate vertical due to gravity.

11. The lid of electric metal pan as set forth in claim 2, wherein said two pins would stop the lid at a certain angle when opening.

12. The appliance for baking flatbread as set forth in claim 1, wherein said the appliance has a concave shaped baking surface at the periphery of the pan to bake ultra-thin flat bread at the periphery.

13. The appliance for baking flatbread as set forth in claim 1, wherein said the appliance has a protruding rim in the outer periphery to properly align the lid.

14. The appliance for baking flatbread as set forth in claim 1, wherein said the appliance has a flat surface on the outer most periphery to support the lid.

15. The appliance for baking flatbread as set forth in claim 1, wherein said the appliance has a unique heating element pattern for uniform heat transfer, with C shaped heating element on the outer periphery of the electric metal pan and Y shaped heating element on the center.

16. The appliance for baking flatbread as set forth in claim 15, wherein said about half section of the heating element embedded in the pan bottom for better heat transfer.

17. The appliance for baking flatbread as set forth in claim 1, wherein said omega shaped metal on cross section to hold the heating element in place.

18. The appliance for baking flatbread as set forth in claim 1, wherein said the baking surface has a low relief conical shape and the pan is thin, as compared to traditional electric Mitad plate.
